(19) United States
(12) Patent Application Publication
(10) Pub. No.: US 2019/0150461 A1
(43) Pub. Date: May 23, 2019

(54) APPARATUS AND METHOD OF PRODUCING SMOKE FOR THE TREATMENT OF FOODSTUFFS

(71) Applicant: ECO SMOKE PTY LTD, Nedlands, Western Australia (AU)

(72) Inventor: Jennifer POLAND, Nedlands (AU)

(21) Appl. No.: 16/098,352

(22) PCT Filed: May 8, 2017
(86) PCT No.: PCT/AU2017/050417

§ 371 Date: Nov. 1, 2018

(30) Foreign Application Priority Data
May 6, 2016 (AU) 2016901689

(51) Int. Cl. A23B 4/052

(52) U.S. Cl. CPC A23B 4/0526; A23V 2002/00

(57) ABSTRACT

A method of producing smoke for the treatment of foodstuffs, the method comprising the steps of providing a supply of sugar alcohol, and heating the sugar alcohol to produce a gaseous product containing vapours and particulate materials. The method further comprises filtering the gaseous product to remove substantially all of the particulate materials and any toxic gases present wherein, in use, an odourless and flavourless smoke is produced.

### FIELD OF THE INVENTION

The present invention relates to industrial food processing and relates more particularly to an apparatus and method of producing smoke for the treatment of foodstuffs.

### BACKGROUND TO THE INVENTION

Methods of treating foodstuffs by smoking to preserve the food and/or enhance the flavour have been employed for millennia. Smoking is well known to assist with preserving the colour, texture, flavour and shelf life of food. More recently the treatment of foodstuffs, such as seafood, to preserve the colour of the flesh has also been practised. Australian patent No 2004224910 by Coral Sea Fishing Pty Ltd describes a method of generating smoke for use in treating food in which charcoal is heated to produce a gaseous stream that includes nitrogen, carbon dioxide and carbon monoxide as the main components. Some particulate material is also present in the gas stream which may impart flavour or odour. The gaseous stream (or smoke) is cooled and filtered to remove particulate material, and the filtered smoke is then stored in pressure storage units for subsequent use in treating a food.

U.S. Pat. No. 5,972,401 by Kowalski describes a process for manufacturing a tasteless super-purified smoke for treating seafood to preserve the freshness, colour texture and natural flavour, particularly after the food is frozen and thawed. In Kowalski the smoke is produced by burning wood sawdust packed in an oxygen retarded retort. The smoke produced from burning wood contains water vapour, CO₂, CO, CH₄ (methane); monoaromatics, guaiacols, phenols, syringols, catechols, tiny particulates of creosote, tar, soot, and trace elements; and over 390 microscopic compounds occurring in either, or both, particulate and gaseous (vapour) phases. To remove taste imparting, and carcinogenic, particulates and vapours, Kowalski passes the smoke through a precipitation filtering tower comprised of filters of ice, cloth, and activated carbon, to produce a super-purified smoke.

One of the disadvantages of both the Coral Sea and Kowalski methods of producing smoke is the associated generation of greenhouse gases as a by-product of the methods and the environmental costs and impact associated with the burning medium. The seafood industry is already being adversely affected by global warming. Any link with processing methods that contribute to high levels of greenhouse gas emissions needs to be avoided. Furthermore, processing methods that contribute to lowering of greenhouse gas emissions need to be supported. For the seafood industry to survive, the industry needs to protect the oceans for future generations.

The present invention was developed with a view to providing a method and apparatus of producing smoke for the treatment of seafood that is more environmentally friendly and ecologically responsible. However it will be understood that the smoke produced according to the method and apparatus of the invention may also be used for treating other kinds of foodstuffs, such as meat, and is not limited in its application to seafood.

References to prior art in this specification are provided for illustrative purposes only and are not to be taken as an admission that such prior art is part of the common general knowledge in Australia or elsewhere.

### SUMMARY OF THE INVENTION

According to a first aspect of the present invention there is provided a method of producing smoke for the treatment of foodstuffs, the method comprising the steps of:

providing a supply of sugar alcohol; and,

heating the sugar alcohol to produce an odourless and flavourless smoke.

Preferably the sugar alcohol is provided in liquid form and the method further comprises the step of transporting the sugar alcohol with a carrier gas to the heating step. Typically the carrier gas is metered at a flow rate of between 0-100 ml/min. Preferably the sugar alcohol is carried with the carrier gas and is dispersed in the heating step by droplets or spraying.

Preferably the sugar alcohol is glycerol. Preferably the glycerol is heated to between 600° C. and 900° C.

Typically the step of heating the sugar alcohol produces a gaseous product containing vapours and particulate materials, and the method further comprises the step of filtering the gaseous product to remove substantially all of the particulate materials and any toxic gases present.

Preferably the method further comprises the step of cooling the gaseous product prior to the filtering step.

According to a second aspect of the present invention there is provided an apparatus for producing smoke for the treatment of foodstuffs, the apparatus comprising:

a heating chamber for heating a sugar alcohol to produce an odourless and flavourless smoke.

Preferably the sugar alcohol is provided in liquid form and the apparatus further comprises a source of a carrier gas for transporting the sugar alcohol with the carrier gas to the heating chamber.

Preferably the sugar alcohol is glycerol. Preferably the glycerol is heated to between 600° C. and 900° C. in the heating chamber. Preferably the heating chamber is filled with a suitable amount of packing material. Packing material may be any material that has a higher boiling point than 900° C., with a small particle diameter. Preferably sand, silicon, carbide or quartz may be used. Preferably silicon carbide with a particle size of 0.15 mm is used. Preferably the sugar alcohol is carried into the heating chamber with the carrier gas and is dispersed over the packing material by droplets or spraying.

Typically a gaseous product containing vapours and particulate materials is produced in the heating chamber, and the apparatus further comprises one or more filters for filtering the gaseous product to remove substantially all of the particulate materials and any toxic gases.

Preferably the apparatus further comprises a cooling coil and further cooling bath for cooling the gaseous product prior to passing it through the one or more filters. The cooling bath is typically an ice water bath through which the smoke is bubbled to cool the gaseous product, condense and remove solid particles.

According to another aspect of the present invention there is also provided a method of treating foodstuffs, the method comprising exposing the foodstuffs to smoke produced according to the above method of the invention.

According to a further aspect of the invention, there is provided a foodstuff, the foodstuff produced by smoke generated in accordance with the method of the above invention.

The invention further provides a method of producing smoke for the treatment of foodstuffs, the method comprising the steps of:

providing a supply of carbohydrate; and,

heating the carbohydrate to produce an odourless and flavourless smoke.

Typically the step of heating the carbohydrate produces a gaseous product containing vapours and particulate materials, and the method further comprises the step of filtering the gaseous product to remove substantially all of the particulate materials and any toxic gases present. In a preferred embodiment the carbohydrate is sugar.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of several specific embodiments of the apparatus and method of producing smoke, given by way of example only, with reference to the accompanying drawings, in which:

FIG. 1 is a schematic diagram illustrating a preferred embodiment of a method and an apparatus for producing smoke according to the present invention.

### DETAILED DESCRIPTION OF PREFERRED EMBODIMENTS

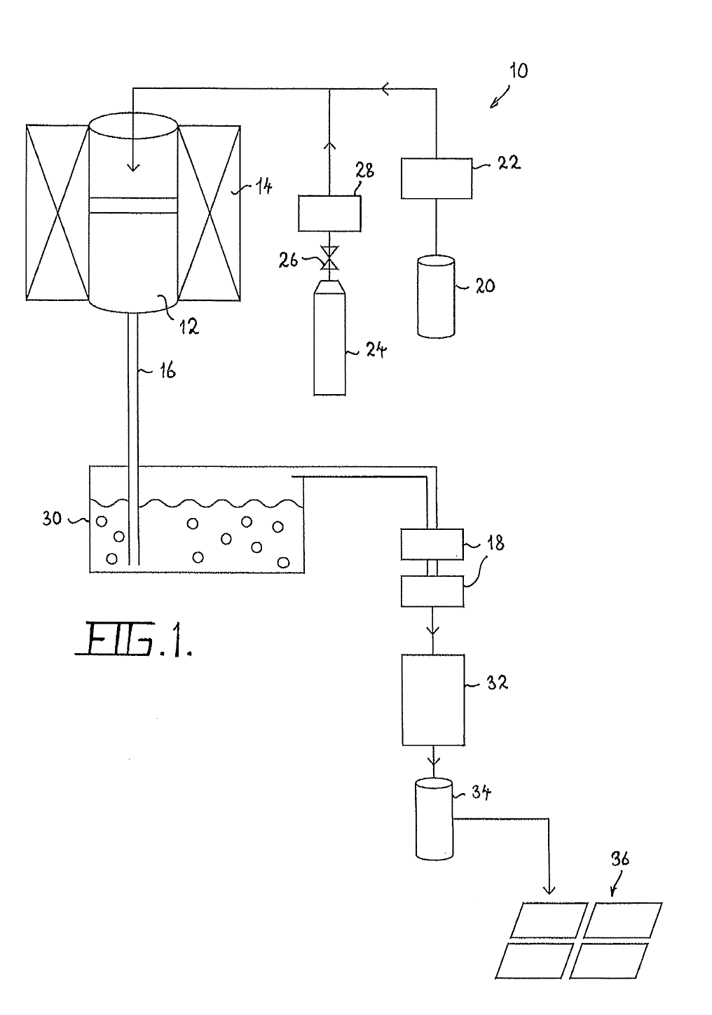

A preferred embodiment of the apparatus 10 for producing smoke for the treatment of foodstuffs in accordance with the invention, as illustrated in FIG. 1, comprises a heating chamber 12 for heating a sugar alcohol. The result of the thermal decomposition of the sugar alcohol is a gaseous product containing vapours and particulate materials. In this embodiment the heating chamber 12 is heated by an electric furnace 14, and the gaseous product (smoke) is collected by a smoke collector 16. The apparatus 10 also includes one or more filters 18 for filtering the gaseous product to remove substantially all of the particulate materials and any toxic gases present, wherein, in use, an odourless and flavourless smoke is produced.

Preferably the sugar alcohol is provided in liquid form in a container 20 and a pump 22 is provided for pumping the liquid from the container 20. Preferably the apparatus 10 further comprises a source 24 of a carrier gas for transporting the sugar alcohol with the carrier gas to the heating chamber 12. In the illustrated embodiment the source of the carrier gas is a cylinder of compressed gas, typically nitrogen, N₂. The carrier gas is released from the gas cylinder via a valve 26 and the flow rate is controlled via a mass flow meter 28 or similar metering device. Any flow rate between 0-100 ml/min may be used, however the optimal flow rate is between 50-70 ml/min.

Heating chamber 12 is typically of tubular shape and is mounted in the electric furnace 14 where it is typically heated to between 600° C. and 900° C. depending on the required output. The heating chamber 12 is filled with a suitable amount of packing material. The packing material is preferably silicon carbide which is advantageous because this material is tolerant of high temperatures. The packing material is suspended on an appropriate mesh to allow for the vapours to pass through the mesh. The packing material assists in maintaining the produced vapours inside the heating chamber for long enough that further reactions may occur, for example thermal cracking of hydrocarbons. The amount of packing material will vary depending on the volume of the heating chamber and required output.

There may be more than one heating chamber depending on the required output and size of the furnace. Preferably the sugar alcohol is carried into the heating chamber 12 with the carrier gas and is dispersed over the packing material by droplets or spraying. The packing material assists with maintaining the vapours inside the heating chamber for a suitable period of time to allow for the necessary reactions to occur. Smoke is collected at other end of the heating chamber 12 by smoke collector 16.

Preferably the sugar alcohol is glycerol. Other kinds of sugar alcohols, such as erythritol, threitol, arabitol, mannitol, and sorbitol, may also be used in the method of the invention. Indeed other kinds of carbohydrates may also be used, such as sugar. Glycerol is a by-product of biofuel production.

Biodiesel has huge potential as an alternative liquid transportation fuel because of its environmental benefits when compared to regular diesel fuels. Biodiesel produces minimal emission of CO₂; it is organically derived; it is renewable; and, it is not dependant on fossil fuel utilisation. Because it is a by-product of biodiesel production, there is currently a glut of glycerol throughout the world, so it is readily available and cheap.

An object of the present invention is to produce a suitable smoke using a cheap and clean burning product, such as glycerol, which is readily available in all parts of the world. Furthermore, by creating a further valuable use for glycerol, the economics of biodiesel production become more viable and it will increase its prevalence over traditional fossil fuel use. The burning of glycerol is very efficient, producing vapours and low levels of solid particles in the gaseous product of heating. Unlike traditional wood smoke, the vapours consist mainly of H₂ and CO. Minimal amounts of N, O₂, CO₂, CH₄, and C₂H₄ are produced. The gaseous product of glycerol heating is rich in the compounds responsible for the preservation of, and reduced oxidation in, foodstuffs, in particular carbon monoxide, CO and hydrogen gas H₂.

Preferably the apparatus 10 further comprises a cooling bath 30 for cooling the gaseous product prior to passing it through a particle filter 18. The cooling bath 30 is typically an ice water bath through which the smoke collected by collector 16 is bubbled to cool the gaseous product, condense and remove solid particles. The particle filter 18 is typically one of a plurality of filters which may include but are not limited to activated carbon, centrifuges, air particle filters, electrostatic filters, bacterial filters, membrane filters, etc. A filter such as a membrane may typically be used to filter the carrier gas as required. However, importantly, only toxic gases need to be filtered out, to ensure the highest level of safety for treatment of food stuff from the relatively clean gaseous product of glycerol heating. With sugar alcohols, such as glycerol, a small amount of toxic gases is typically produced during heating.

Advantageously an odourless, colourless and flavourless smoke is produced. The smoke passes into a compressor 32 and is stored in pressurised storage units or canisters 34 in known manner. The smoke is typically used for treating foodstuffs 36 by direct contact, although other methods of contact may also be employed. Typically the foodstuffs, e.g. tuna, are treated with the smoke at between 0-4° C., and for varying lengths of time, typically between 1-48 hours.

Now that preferred embodiments of the apparatus and method of producing smoke for treating foodstuffs have been described in detail, it will be apparent that the described embodiments provide a number of advantages over the prior art, including the following:
(i) The smoke produced has the attributes and qualities pertinent to smoking without the traditional odours or flavours, and with the added benefit of additional preservative gases, in a way that supports ecofriendly processes.
(ii) Glycerol is particularly advantageous as it is cheap and abundantly available, and the gaseous product of its heating is rich in the compounds responsible for the preservation of, and reduced oxidation in, foodstuffs.
(iii) Prior art methods of smoke production contain high levels of taste and odour imparting gaseous compounds due to elemental components of the wood, which may be imparted into foodstuffs. Also, there are often carcinogens present in the smoke. With sugar alcohols, apart from a small amount of toxic gases that must be removed for health reasons, the smoke generated has no smokey flavour or odour imparting gaseous compounds and therefore there is no need for the smoke to be super-purified.
(iv) More recently, the benefits of using different gases (like hydrogen) on food products have been investigated. The smoke generated has the optimal combination of gases present in the smoke to achieve preservation and enhancement of the food product, above the benefits of traditionally composed smoke.

It will be readily apparent to persons skilled in the relevant arts that various modifications and improvements may be made to the foregoing embodiments, in addition to those already described, without departing from the basic inventive concepts of the present invention. For example, the manner of heating the sugar alcohol and cooling the resulting product may vary considerably from that described above. Therefore, it will be appreciated that the scope of the invention is not limited to the specific embodiments described.

1. A method of producing smoke for the treatment of foodstuffs, the method comprising the steps of:
providing a supply of sugar alcohol;
heating the sugar alcohol, wherein the step of heating the sugar alcohol produces a gaseous product containing vapours and particulate materials; and,
filtering the gaseous product to remove substantially all of the particulate materials and any toxic gases present apart from carbon monoxide to produce an odourless and flavourless smoke.

2. A method of producing smoke as defined in claim 1, wherein the sugar alcohol is provided in liquid form.

3. A method of producing smoke as defined in claim 2, further comprising the step of transporting the sugar alcohol with a carrier gas to the heating step.

4. A method of producing smoke as defined in claim 3, wherein the carrier gas is metered at a flow rate of between 0-100 ml/min.

5. A method of producing smoke as defined in claim 3, wherein the sugar alcohol is carried with the carrier gas and is dispersed in the heating step by droplets or spraying.

6. A method of producing smoke as defined in claim 1, wherein the sugar alcohol is glycerol.

7. A method of producing smoke as defined in claim 6, wherein the glycerol is heated to between 600° C. and 900° C. in the heating step.

8. A method of producing smoke as defined in claim 1, wherein the method further comprises the step of cooling the gaseous product prior to the filtering step.

9. An apparatus for producing smoke for the treatment of foodstuffs, the apparatus comprising:
a heating chamber in which a sugar alcohol is heated, wherein a gaseous product containing vapours and particulate materials is produced in the heating chamber; and,
one or more filters for filtering the gaseous product to remove substantially all of the particulate materials and any toxic gases apart from carbon monoxide to produce an odourless and flavourless smoke.

10. An apparatus for producing smoke as defined in claim 9, wherein the sugar alcohol is provided in liquid form.

11. An apparatus for producing smoke as defined in claim 10, further comprising a source of a carrier gas for transporting the sugar alcohol with the carrier gas to the heating chamber.

12. An apparatus for producing smoke as defined in claim 9, wherein the sugar alcohol is glycerol.

13. An apparatus for producing smoke as defined in claim 12, wherein the glycerol is heated to between 600° C. and 900° C. in the heating chamber.

14. An apparatus for producing smoke as defined in claim 10, wherein the heating chamber is filled with a suitable amount of packing material.

15. An apparatus for producing smoke as defined in claim 14, wherein the packing material is any material that has a higher boiling point than 900° C., with a small particle diameter.

16. An apparatus for producing smoke as defined in claim 15, wherein sand, silicon, carbide or quartz is used as the packing material.

17. An apparatus for producing smoke as defined in claim 16, wherein silicon carbide with a particle size of 0.15 mm is used as the packing material.

18. An apparatus for producing smoke as defined in claim 10, wherein the sugar alcohol is carried into the heating chamber with the carrier gas and is dispersed over the packing material by droplets or spraying.

19. An apparatus for producing smoke as defined in claim 9, wherein the apparatus further comprises a cooling coil and a further cooling bath for cooling the gaseous product prior to passing it through the one or more filters.

20. An apparatus for producing smoke as defined in claim 19, wherein the cooling bath is an ice water bath through which the smoke is bubbled to cool the gaseous product, condense and remove solid particles.

21. A method of treating foodstuffs, the method comprising exposing the foodstuffs to smoke produced according to the method as defined in claim 1.

22. A foodstuff treated by smoke produced in accordance with the method as defined in claim 1.

23-27. (canceled)
